(19) United States
(12) Patent Application Publication
(10) Pub. No.: US 2026/0351037 A1
(43) Pub. Date: Nov. 5, 2026

(54) SYSTEMS AND METHODS FOR EXTRACTING TABLE DATA FROM DATA TABLE IMAGES

(71) Applicant: Schlumberger Technology Corporation, Sugar Land, TX (US)

(72) Inventors: Ritik Shrivastava, Pune (IN); Omkar Anil Gune, Pune (IN); Purnaprajna Raghavendra Mangsuli, Pune (IN)

(21) Appl. No.: 19/252,464

(22) Filed: Jun. 27, 2025

(30) Foreign Application Priority Data
Apr. 30, 2025 (IN) 202511041671

(51) Int. Cl. G06V 30/412; G06F 40/279; G06V 30/146; G06V 30/148; G06V 30/19; G06V 30/414

(52) U.S. Cl. CPC G06V 30/412; G06F 40/279; G06V 30/1475; G06V 30/148; G06V 30/19007; G06V 30/414

(57) ABSTRACT

The present disclosure relates to systems and methods for extracting table data from data table images using a hybrid combination of optical character recognition (OCR)-based pattern recognition or matching algorithms and a large language model (LLM). For example, a method may include accessing, via a table data extraction system, an image of a data table; utilizing, via the table data extraction system, the hybrid combination of the OCR-based pattern recognition or matching algorithms and the LLM to extract table data included in the data table; and storing, via the table data extraction system, the extracted table data in a database.

### CROSS-REFERENCE TO RELATED APPLICATION

This application claims priority to and the benefit of Indian Application No. 202511041671, entitled “SYSTEMS AND METHODS FOR EXTRACTING TABLE DATA FROM DATA TABLE IMAGES,” filed Apr. 30, 2025, which is hereby incorporated by reference in its entirety for all purposes.

### BACKGROUND

The present disclosure relates generally to systems and methods for extracting table data from data table images using a hybrid combination of optical character recognition (OCR)-based pattern recognition or matching algorithms and a large language model (LLM).

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Modern organizations often produce and manage a large amount of data. The data may present in documents, such as reports (e.g., sales reports, inspection reports), knowledge articles, promotional materials, user manuals, and so forth. Additionally, the data may record measurements associated with various assets of the company. In an oil and gas organization context, the assets may include completed wells, geological areas for potential drilling, drilling equipment, production equipment, and the like. In any case, the data may include details or discussion related to one or more topics. However, since the amount of data produced and managed by the organization may be enormous, it can be difficult for the organizations to organize the data. Further, it may be difficult for a user to navigate the large amounts of data and identify topics of interest. Further, it can also be challenging for a user to find similar or related data within the large number of documents. This can lead to inefficiencies and additional operational costs as users can spend inordinate amounts of time searching and reviewing documents in an attempt to locate particular topics and/or related data.

In addition, many older documents hold valuable and critical information that can significantly contribute to various fields of research and applications. This information may be presented in diverse formats, including text, tables, graphs, and charts. Among these, tables often encapsulate structured data that is essential for interpretation and analysis. Extracting tables from such documents requires specialized methods to preserve their inherent structure, including rows and columns, which are often lost when treated as plain text.

Traditional deep learning approaches face notable challenges in this regard:
Inefficient handling of large tables: Tables with a high number of rows or columns frequently lead to processing failures due to computational limitations or structural complexities.
Limited reliability with complex arrangements: Traditional models often struggles to process tables with intricate layouts, leading to inaccuracies in the extracted data.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In certain embodiments, the present disclosure relates to a method that includes accessing, via a table data extraction system, an image of a data table. In addition, the method includes utilizing, via the table data extraction system, a hybrid combination of optical character recognition (OCR)-based pattern recognition or matching algorithms and a large language model (LLM) to extract table data included in the data table. In addition, in certain embodiments, the method includes storing, via the table data extraction system, the extracted table data in a database.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a diagram of a system configured to implement a table data extraction system in a client-server architecture, in accordance with embodiments of the present disclosure;

FIG. 2 illustrates a data processing workflow for extracting data from tables in table image using multimodal large language model (LLM) techniques, in accordance with embodiments of the present disclosure;

FIG. 3 illustrates an example of an original table image that may be analyzed by a table data extraction system, in accordance with embodiments of the present disclosure;

FIG. 4 illustrates example LLM output determined by the data processing workflow of FIG. 2, in accordance with embodiments of the present disclosure;

FIG. 5 illustrates extracted text and bounding boxes for all detected words using optical character recognition (OCR)-based pattern recognition or matching algorithms, in accordance with embodiments of the present disclosure;

FIG. 6 illustrates a header bounding box and a table image without header, in accordance with embodiments of the present disclosure;

FIG. 7 illustrates example column bounding boxes and row bounding boxes that result from certain steps of the data processing workflow of FIG. 2, in accordance with embodiments of the present disclosure;

FIG. 8 illustrates output of a mapping of OCR results, in accordance with embodiments of the present disclosure;

FIG. 9 illustrates an example of most relevant rows having values for the most columns, in accordance with embodiments of the present disclosure;

FIG. 10 illustrates example output from an LLM, in accordance with embodiments of the present disclosure;

FIG. 11 illustrates an example mapping of structural columns to column names, in accordance with embodiments of the present disclosure;

FIG. 12 illustrates example table data output where the table structure has been finalized, in accordance with embodiments of the present disclosure;

FIG. 13 illustrates an example table image that may be analyzed using an LLM-only approach versus the hybrid OCR-based pattern recognition or matching algorithms with LLM approach described herein, in accordance with embodiments of the present disclosure;

FIG. 14 illustrates the results of analyzing the table image of FIG. 13 using an LLM-only approach, in accordance with embodiments of the present disclosure;

FIG. 15 illustrates the results of analyzing the table image of FIG. 13 using the hybrid OCR-based pattern recognition or matching algorithms with LLM approach described herein, in accordance with embodiments of the present disclosure; and

FIG. 16 is a flow diagram of a method for utilizing a table data extraction system to extract table data from table images, in accordance with embodiments of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a”, “an”, and “the” are intended to mean that there are one or more of the elements. The terms “comprising”, “including”, and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

In addition, as used herein, the terms “real time”, “real-time”, or “substantially real time” may be used interchangeably and are intended to describe operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “continuous”, “continuously”, or “continually” are intended to describe operations that are performed without any significant interruption. For example, as used herein, control commands may be transmitted to certain equipment every five minutes, every minute, every 30 seconds, every 15 seconds, every 10 seconds, every 5 seconds, or even more often, such that operating parameters of the equipment may be adjusted without any significant interruption to the closed-loop control of the equipment. In addition, as used herein, the terms “automatic”, “automated”, “autonomous”, and so forth, are intended to describe operations that are performed are caused to be performed, for example, by a computing system (i.e., solely by the computing system, without human intervention). Indeed, it will be appreciated that the analysis and control system described herein may be configured to perform any and all of the data processing functions described herein automatically.

In addition, as used herein, the term “substantially similar” may be used to describe values that are different by only a relatively small degree relative to each other. For example, two values that are substantially similar may be values that are within 10% of each other, within 5% of each other, within 3% of each other, within 2% of each other, within 1% of each other, or even within a smaller threshold range, such as within 0.5% of each other or within 0.1% of each other.

As mentioned above, organizations may generate large amounts of data. Further, the data may be structured (e.g., data organized in databases or schemas using SQL) or non-structured data (e.g., series of documents, PDFs, images, log files of seismic data, articles, reports, and the like). While it may be advantageous to incorporate all of this data into databases, the large amount of data makes onboarding data to these environments difficult. For example, the data may be provided by a variety of sources (e.g., other organizations), and the data may have formats specific to the sources. Accordingly, when an organization desires to build a database to store this data, organizations perform data ingestion, that includes reformatting the data to a particular form, quality controlling it, matching the format of the new system, and so on, which utilizes a large amount of resources (e.g., manhours) and, thus, is relatively expensive.

It is presently recognized that large language models (LLMs) may be employed to facilitate the data ingestion. Generative AI (Gen AI) tools, such as ChatGPT, utilize LLMs that enable users to converse with AI. While such Gen AI tools are excellent at providing broad information, it is presently recognized that it may be difficult to implement existing LLM tools (e.g., Gen AI) in organizations that store and manage sensitive information. For example, organizations may use organization-specific language, and the meanings of certain organization-specific words and phrases (e.g., organization-specific semantic terminology) may be lost when an LLM is trained on data from different organizations that may use the same word, but in different contexts or with different meanings (e.g., resources may refer to natural resources, such as oil, but certain organizations may use resource to refer to employees).

As also mentioned above, traditional deep learning approaches experience certain difficulties when extracting tables from documents including, but not limited to, inefficient handling of large tables and limited reliability with complex arrangements. The embodiments described herein include techniques for overcoming these limitations. The embodiments described herein ensure that the structural integrity of tables is preserved during extraction, allowing for accurate and meaningful analysis of the data contained therein. By leveraging image processing based techniques and LLMs, the inefficiencies and reliability issues associated with existing methods are addressed, ensuring robust and precise table extraction from images of documents.

The embodiments described herein introduce cost-efficient and low-latency methods to extract tables from images in documents using LLMs. The embodiments described herein leverage both text-based and multimodal LLMs to address challenges associated with direct use of multimodal LLMs for tasks such as converting table images into CSV format.

Directly relying on multimodal LLMs can lead to several issues, including:
Accuracy degradation for large tables: As the table size increases, the output of the LLM becomes inconsistent and error prone.
Confusion caused by empty cells: Blank entries in the table can lead to misinterpretations by the LLM.
High latency: Processing long and complex tables often results in significant delays.

Furthermore, using only traditional deep learning methods for table extraction, for example, such as Detection Transformer (DETR) that use purely vision-based models and may not understand the context (e.g., column names, column values, and so forth) has the drawback of requiring training on customer table data, and so forth. Moreover, traditional deep learning based models can have an upper limit on the number of bounding boxes they can return and might cause concatenation of bounding boxes for larger tables.

To overcome these challenges, the embodiments described herein include novel pre-processing techniques. For example, the embodiments described herein first crop the image and then send it to the LLM. In addition, this change may also need to be translated whenever relevant. Cropping of the image is generally required because images are typically resized to smaller dimensions by multimodal LLMs for processing. In such cases, images of dense table may have loss of information.

In summary, the embodiments described herein include specific processing steps configured to enhance the accuracy and speed of processing of extracting data from tables included in documents. In particular, a summary of the processing steps includes:
1. Skew Correction: Detect if an image of a table is skewed and, if yes, rotate it accordingly to correct the skew.
2. Optical Character Recognition (OCR) Analysis: Perform OCR on the table image to extract text
3. Row and Column Detection: Using the OCR output, accurately determine the structural layout of the table. As described in greater detail herein, a novel algorithm is implemented to detect columns using the OCR output.
4. Incremental Prompting: Prompt the LLM to process only the first row of the table for initial understanding.
5. Header Identification: Identify the headers of the table by mapping OCR-detected text to their corresponding rows.
6. Header and Sample Row Selection: Crop the table headers and select a subset of rows, ensuring at least one row contains a value for each column.
7. Column Value Extraction: Provide the cropped header and selected rows to the LLM, prompting it to identify column names and their corresponding values.
8. Column-Header Mapping: Use the values returned by the LLM to accurately map columns to their respective headers.

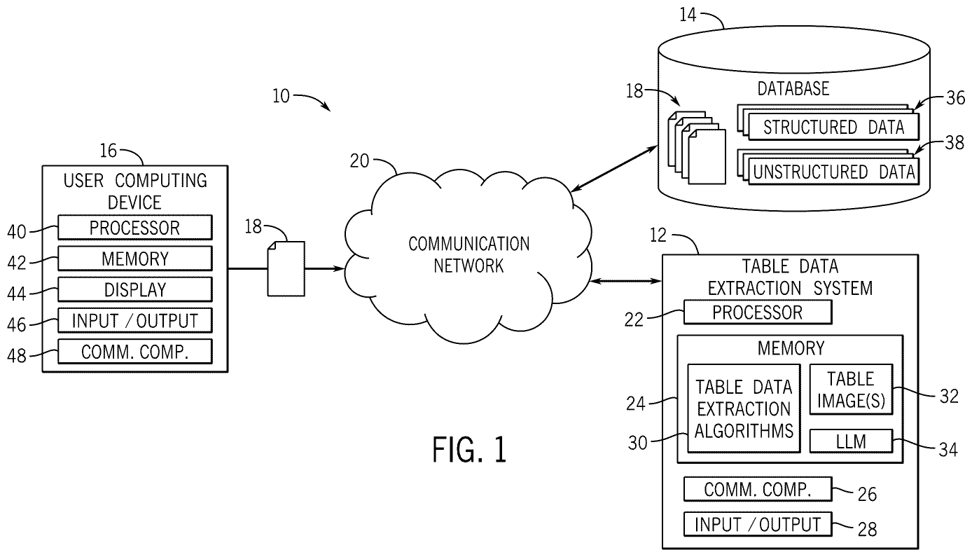

With the foregoing in mind, FIG. 1 is a block diagram of a system 10 in accordance with the present disclosure. As illustrated, the system 10 includes a table data extraction system 12 and a database 14. In certain embodiments, the table data extraction system 12 may communicate with a user computer device 16 to access documents 18 stored on the user computer device 16 and/or to access documents 18 already stored in the database 14, or a combination thereof, via a communication network 20, to enable analysis of the documents 18 by the table data extraction system 12 for the purpose of extracting table data from the documents 18, as described in greater detail herein. As illustrated, in certain embodiments, the table data extraction system 12 may include a processor 22, a memory 24 or other storage, communication component(s) 26, and input/output device(s) 28. As illustrated, the memory 24 may store the table data extraction algorithms 30 described in greater detail herein. As described in greater detail herein, the table data extraction algorithms 30 enable the table data extraction system 12 to extract table data from table images 32 (e.g., the documents 18 themselves or image scans of portions of the documents 18), for example, using a unique hybrid combination of OCR-based pattern recognition or matching techniques and an LLM 34.

As illustrated, the database 14 may store both structured data 36 and unstructured data 38 along with the various documents 18 that may be stored locally in the database 14. In certain embodiments, the database 14 may be a publicly-accessible oil and gas database platform (e.g., open subsurface data universe (OSDU)) or other database platform storing data in one or more formats.

As also illustrated, in certain embodiments, the user computing device 16 may include a processor 40, a memory 42, a display 44, input/output device(s) 46, and communication component(s) 48. In general, the components of the user computing device 16 may be generally similar to the components of the table data extraction system 12. The display 44 of the user computing device 16 may display a user interface that may facilitate interactions with the table data extraction system 12 that is implementing the table data extraction algorithms 30 described in greater detail herein.

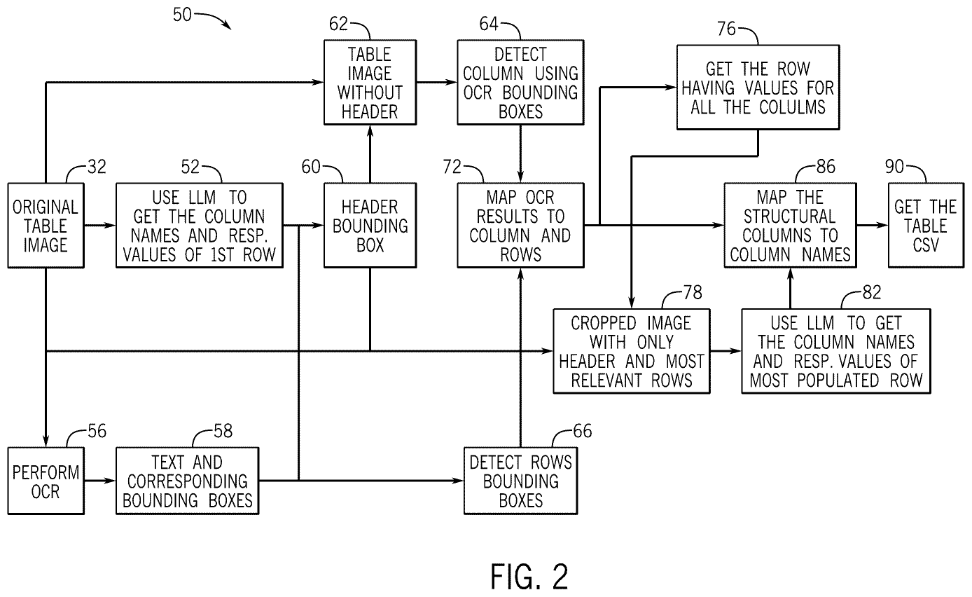

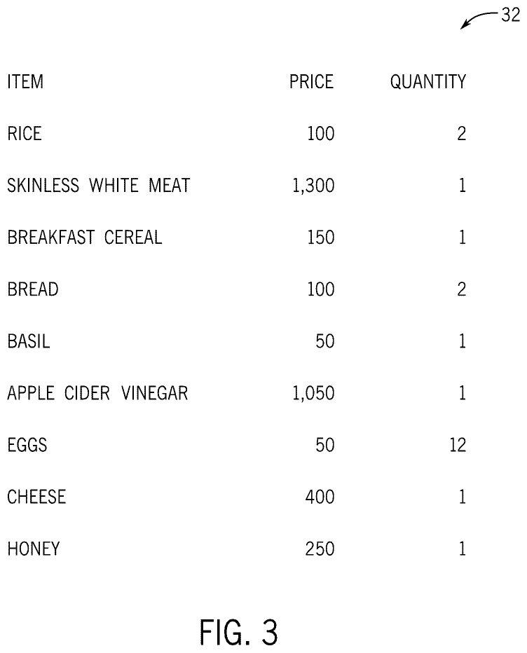

FIG. 2 illustrates a data processing workflow 50 for extracting data from tables in table images 32 by the table data extraction system 12 using multimodal LLM techniques, as described in greater detail herein. As illustrated in FIG. 2, in certain embodiments, the data processing workflow 50 may begin with accessing an original table image 32 (e.g., a document 18 or an image scan of a portion of a document 18). FIG. 3 illustrates an example of an original table image 32 that may be analyzed by the table data extraction system 12. As illustrated, the example table image 32 includes three columns (e.g., Item, Price, and Quantity) and nine rows (e.g., nine food items having respective prices and quantities).

In certain embodiments, accessing the original table image 32 may include determining if the table image 32 is skewed (e.g., such that the column headers are not perfectly aligned horizontally and/or that the data in the rows are not perfectly aligned vertically) and, if the table image 32 is determined to be skewed, rotating the table image 32 to correct the skew (e.g., such that the column headers are generally aligned horizontally and the data in the rows are generally aligned vertically). In other words, the table image 32 may be pre-processed by the table data extraction system 12 to correct skew to enable accurate OCR and table detection, as described in greater detail herein. In certain embodiments, the table data extraction system 12 may be configured to display the table image 32, for example, via a user interface presented on a display 44 of a user computing device 16 to enable a user to further tweak the alignment of the table image 32 by, for example, manipulating input/output device(s) 46 of the user computing device 16.

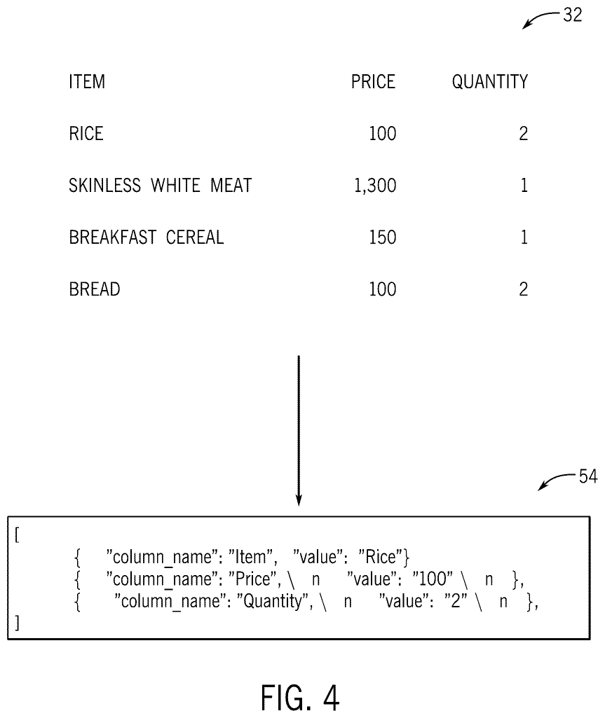

Returning to FIG. 2, once the table image 32 is correctly aligned, the data processing workflow 50 may include using an LLM 34 to determine the column names and respective values of the first row of the table image 32 (step 52). FIG. 4 illustrates example LLM output 54 that is determined in step 52 of the data processing workflow 50, for example, three data pairs of “column_name” and “value” that correspond to the three column values in the first row of the table image 32.

In certain embodiments, only the top half of the table may be cropped to be analyzed. For example, as illustrated in FIG. 4, in certain embodiments, a relatively small subset of the table rows (e.g., the first 10% of the table rows, in certain embodiments) may be extracted and saved as an image called top_image for analysis. From there, top_image may be passed to a multimodal LLM to identify table headers and retrieve the values in the first row corresponding to each header.

In addition, in certain embodiments, the LLM 34 may be continually retrained during processing of a plurality of table images 32. For example, in certain embodiments, the LLM 34 may be automatically retrained by the table data extraction system 12 by continually identifying, as a list of non-limiting example, certain column names that are more common or less common in table images 32 from a particular organization, certain column names that are more common or less common when they are included in table images 32 having other identified column names, certain column names that are more common or less common when they are accompanied with particular types of irregularities (e.g., in scanned versions of the table images 32 to, for example, identify potential similarity of the source, age, and so forth), certain row values that are more common or less common in table images 32 from a particular organization, certain row values that are more common or less common when they are included in table images 32 having other identified row values in a particular row, and/or certain row values that are more common or less common when they are accompanied with particular types of irregularities (e.g., in scanned versions of the table images 32 to, for example, identify potential similarity of the source, age, and so forth).

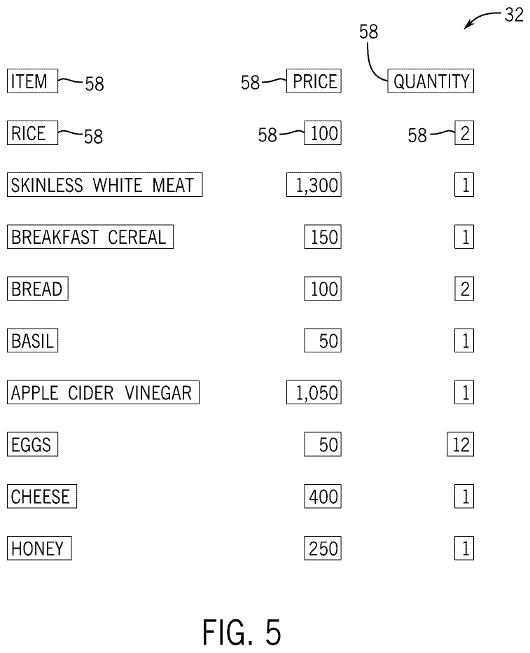

Returning to FIG. 2, in parallel with step 52, the data processing workflow 50 may also include performing OCR on the table image 32 to extract text and associated bounding boxes for all detected words using OCR algorithms (step 56), as illustrated in FIG. 5. In certain embodiments, the bounding boxes 58 for each detected text may be represented as (x₀, y₀, x₁, y₁), as described in greater detail herein.

In addition, in certain embodiments, the OCR-based pattern recognition or matching algorithms used by the table data extraction system 12 to detect the bounding boxes 58 may be continually modified based, for example, on observed accuracy of the final table data extraction. For example, if the table data extraction system 12 identifies that certain inaccuracies have occurred for a set of extracted table data, the table data extraction system 12 may automatically modify the OCR-based pattern recognition or matching algorithms that are used to detect the bounding boxes 58. For example, the OCR-based pattern recognition or matching algorithms may be automatically modified to take particular irregularities (e.g., irregular marks in the table images 32, irregular spacing of columns and/or rows, and so forth), which may have caused the inaccuracies, into account for future OCR passes.

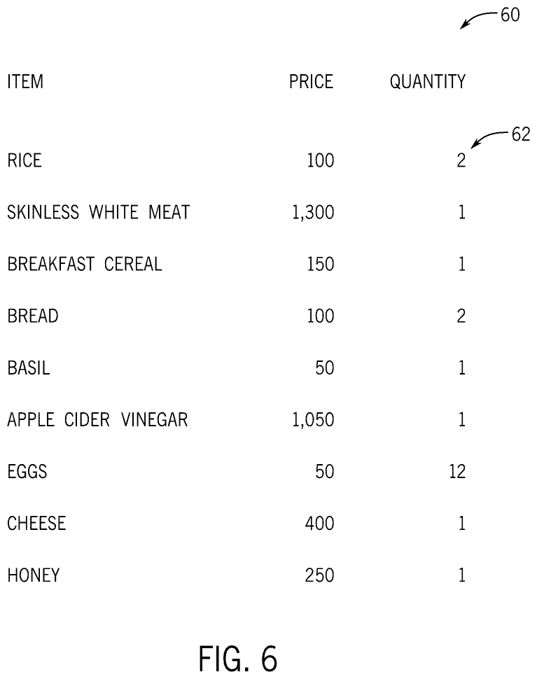

FIG. 6 illustrates a header bounding box 60 and a table image without header 62, which result from steps 52 and 56 of the data processing workflow 50. As such, the table image 32 may be split by using the first row values and headers to divide the table image 32 into (1) table_image_with_header 60, which contains only the headers and (2) table_image_without_header 62, which contains the table values, excluding the headers.

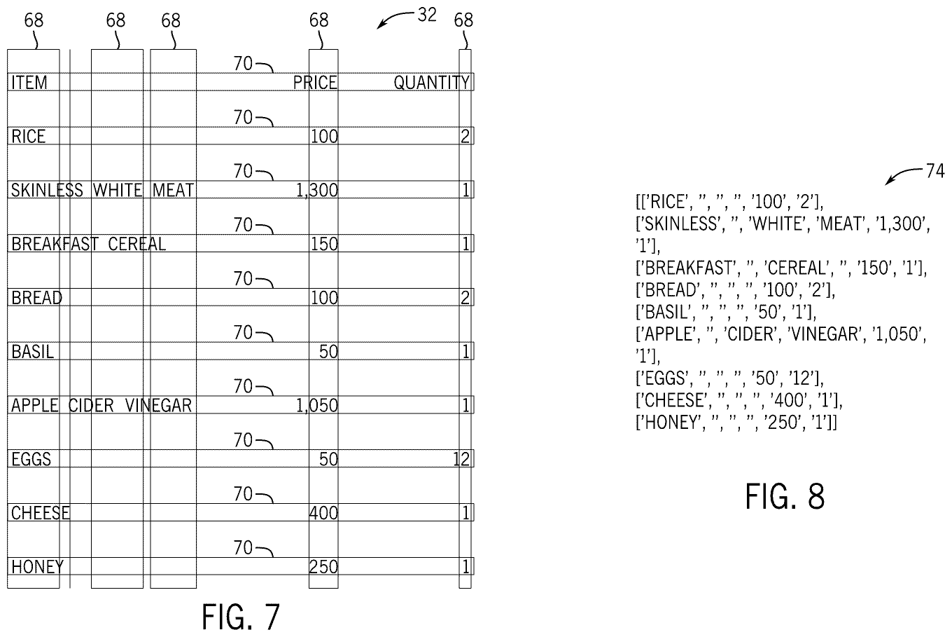

Returning to FIG. 2, the data processing workflow 50 may also include detecting column bounding boxes (step 64) and row bounding boxes (step 66) using OCR bounding boxes of the table image without header 62 and the text and corresponding bounding boxes 58. FIG. 7 illustrates example column bounding boxes 68 and row bounding boxes 70 that result from steps 64 and 66 of the data processing workflow 50.

In certain embodiments, to ensure robust detection of the columns using OCR bounding boxes:
1. Create an array value_count of size equal to the table image width and initialize all values to 0.
2. For each bounding box (x₀, y₀, x₁, y₁), increment value_count for all indices between [x₀, x₁].
3. Use Otsu's binarization, or other suitable image thresholding techniques, to compute a threshold for value_count.
4. Mark column boundaries where value_count exceeds the threshold.
5. For any text detected by OCR that does not fall within a column bounding box:
   a. Add a new column bounding box to enclose it.

In addition, in certain embodiments, to detect the rows using OCR bounding boxes, a deterministic algorithm may be used to group bounding boxes into rows:
1. Sort bounding boxes by the y₀ coordinate (top boundary of each box).
2. Assign a variable start_row to each bounding box, initializing all to 0.
3. Set start_row=1 for the first bounding box.
4. For each subsequent bounding box, compare it with the previous one:
   a. Calculate the vertical intersection i_{y} between the y-coordinates of the current and previous bounding box.
   b. If i_{y}>intersection_threshold:
      i. Continue (the current box is in the same row as the previous one).
   c. Otherwise:
      i. Mark start_row=0 (a new row starts from this box).
5. Group bounding boxes by start_row to identify rows and determine their bounding boxes.

In addition, in certain embodiments, the OCR-based pattern recognition or matching algorithms used by the table data extraction system 12 to detect the bounding boxes 68, 70 may be continually modified based, for example, on observed accuracy of the final table data extraction. For example, if the table data extraction system 12 identifies that certain inaccuracies have occurred for a set of extracted table data, the table data extraction system 12 may automatically modify the OCR-based pattern recognition or matching algorithms that are used to detect the bounding boxes 68, 70. For example, the OCR-based pattern recognition or matching algorithms may be automatically modified to take particular irregularities (e.g., irregular marks in the table images 32, irregular spacing of columns and/or rows, and so forth), which may have caused the inaccuracies, into account for future OCR passes.

Returning to FIG. 2, the data processing workflow 50 may also include mapping the OCR results (i.e., the column and row bounding boxes 68, 70) (step 72). FIG. 8 illustrates the output 74 of the mapping of the OCR results (e.g., a comma-delimited list corresponding to the data included in the OCR results, for example).

Then, retuning to FIG. 2, the data processing workflow 50 may also include determining the most relevant rows having values for all columns (step 76) and cropping the table image 32 with only the header bounding box 60 and the most relevant rows having values for all columns that is determined in step 76 (step 78). In certain embodiments, the following algorithm may be used to select the most relevant rows 80:
1. Initialize an empty set Sᵣ for selected rows and a set S_{c} for columns.
2. Identify the row with the most values across all columns (Pᵣ) and add it to Sᵣ.
3. For each column E_{col} where Pᵣ has an empty value:
   a. Find rows with values in E_{col} and add them to Sᵣ.

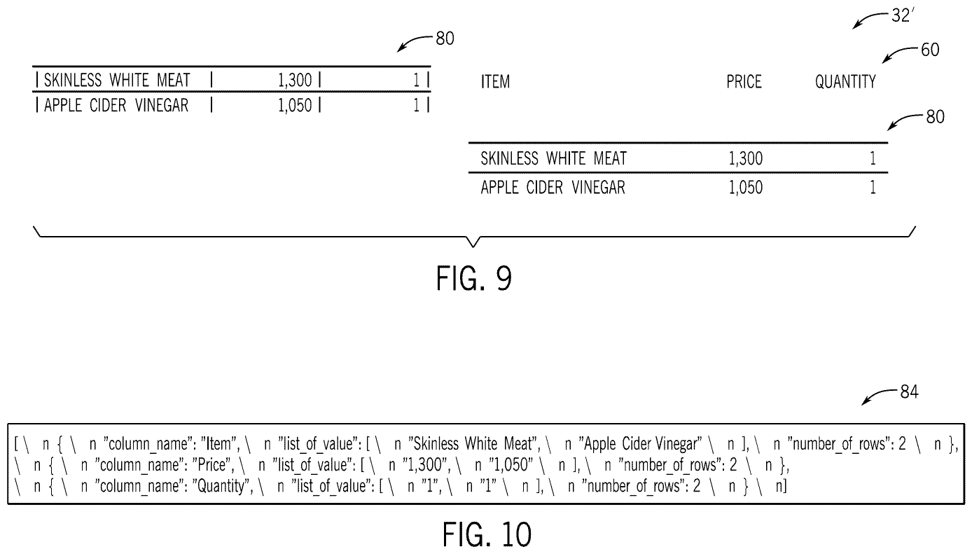

FIG. 9 illustrates an example of the most relevant rows 80 having values for the most, or even all, columns (e.g., the rows relating to Skinless White Meat and Apple Cider Vinegar, in this instance) and an example of a cropped table image 32′ with only header bounding box 60 and the most relevant rows 80 having values for the most, or even all, columns. In particular, FIG. 9 illustrates an example cropping of the table image 32′ to include all rows in Sᵣ 80 and the column headers 60.

Then, returning to FIG. 2, the data processing workflow 50 may also include mapping the structural columns to column names using an LLM 34 to determine the column names and respective values of the cropped table image 32′ (step 82). FIG. 10 illustrates example output 84 from the LLM 34. In particular, FIG. 10 illustrates an example cropping the table image 32′ to include all rows in Sᵣ 80 and the column headers 60.

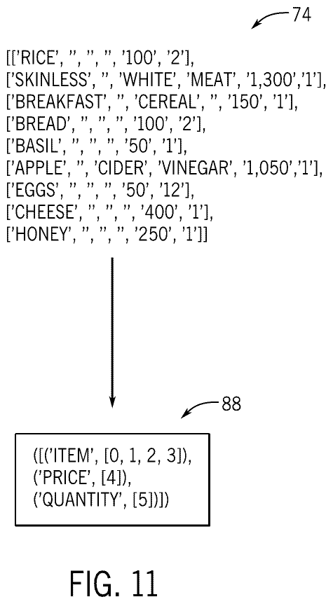

Then, returning to FIG. 2, the data processing workflow 50 may also include mapping the structural columns of the output 74 of the mapping of the OCR results (i.e., the column and row bounding boxes 68, 70) illustrated in FIG. 8 that is determined in step 72 of the data processing workflow 50 (step 86). FIG. 11 illustrates an example mapping 88 of structural columns to column names.

Then, all of the values in the output 74 of the mapping of the OCR results may be assigned columns using the mapping 88 of the structural columns to column names that is generated using the LLM 34 by: (1) passing the cropped table image 32′ to the LLM to determine which column each value belongs to (e.g., the mapping 88 of the structural columns to column names), and (2) mapping the LLM results to the output 74 of the mapping of the OCR results.

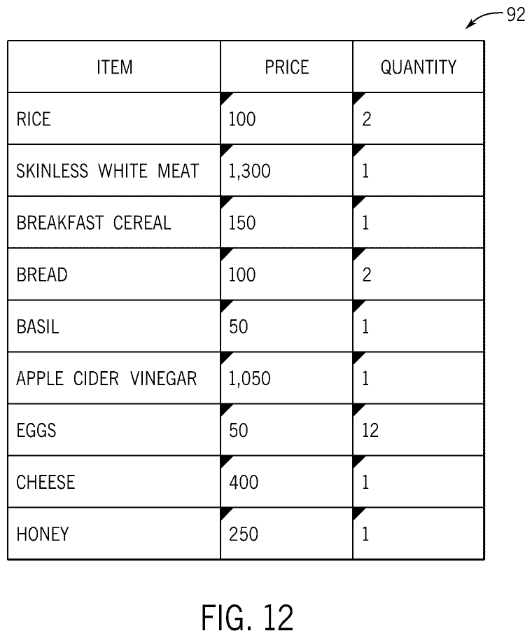

Then, returning to FIG. 2, the data processing workflow 50 may also include determining the final text data (e.g., in .csv data format, in certain embodiments) by applying the mapping 88 of structural columns to column names to the output 74 of the mapping of the OCR results (i.e., the column and row bounding boxes 68, 70) (step 90). FIG. 12 illustrates example table data output 92 where the table structure has been finalized by using the mapping 88 of structural columns to column names to: (1) align the detected structural columns in the output 74 of the mapping of the OCR results with the identified column headers, and (2) construct the final table data output using this mapping 88.

The embodiments described above can be extended to other uses. For example, as described in greater detail above, a table image 32 may be cropped and the cropped version of the image 32 may be sent to a multimodal LLM (e.g., Visual LM) for efficient recognition of column headers and associated column values. However, in other embodiments, only text-based LLMs may be used to identify the header/column names of a particular table. Furthermore, in certain embodiments, the text-based LLMs may also be used to identify the column values. Alternatively, in certain embodiments, using OCR output that contains the detected text and (x, y, width, height) positions of text, it may also be possible to identify spatial positioning of words in a given table if the text and bounding box information are sent to a text-based LLM, which may be prompted to analyze the information to identify the spatial structure of the tabular data.

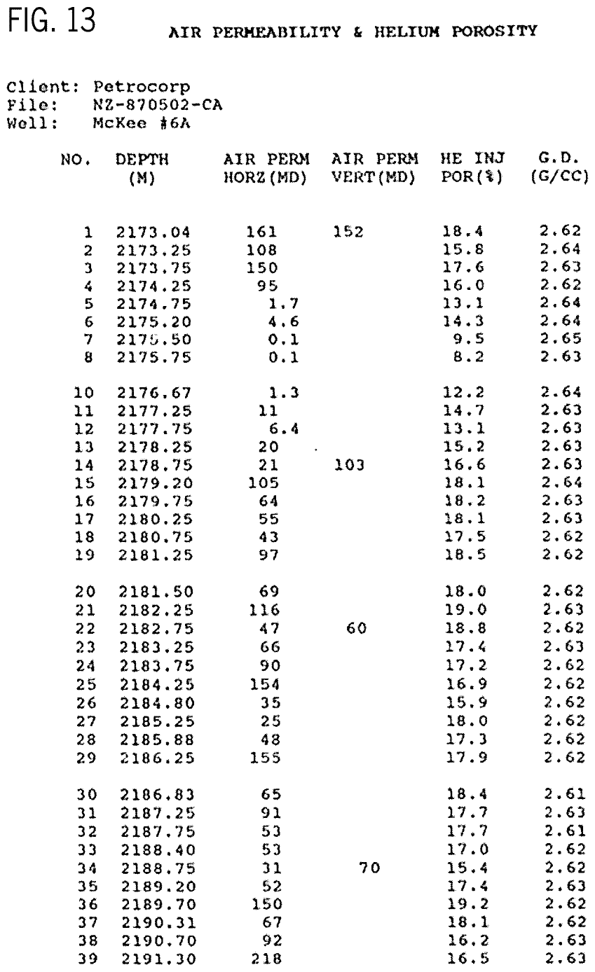

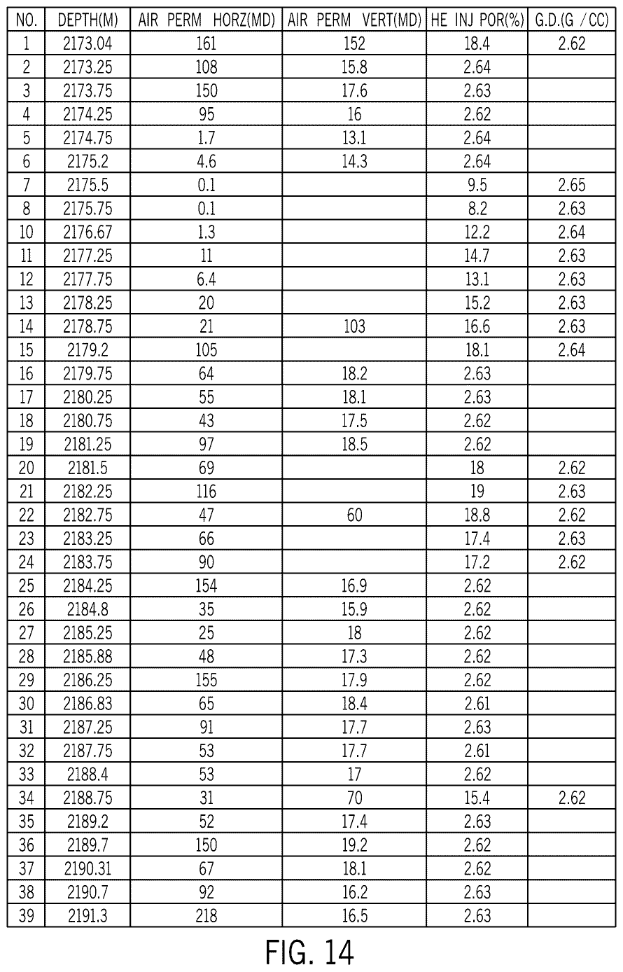

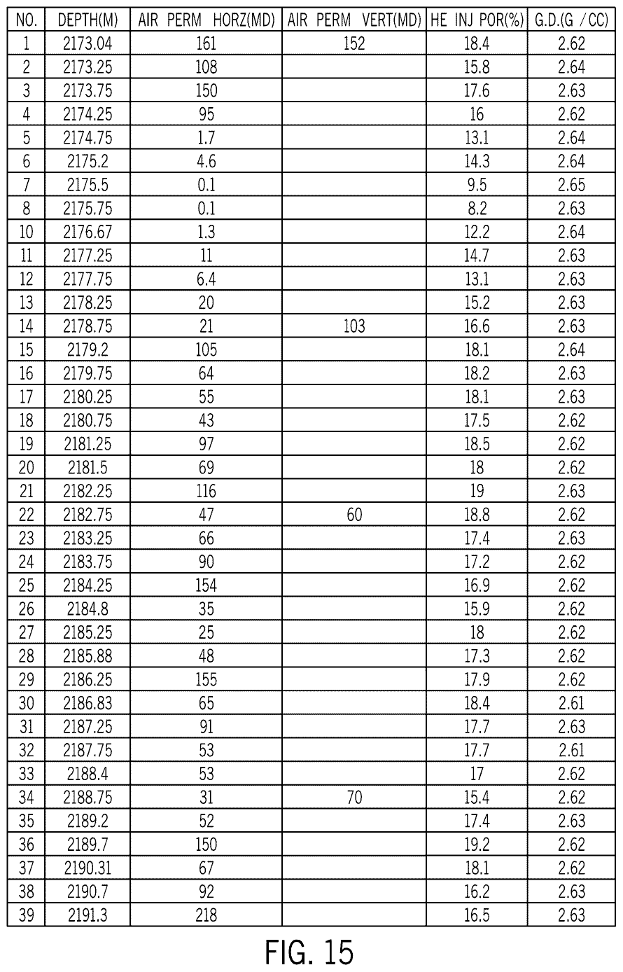

FIGS. 13 through 15 illustrate the difference between the processing of table data (e.g., illustrated in FIG. 13) using an LLM-only approach (see FIG. 14) and using the hybrid combination of OCR-based pattern recognition or matching techniques and an LLM 34 (see FIG. 15). As observed, the LLM-only method may struggle to handle empty cells correctly (e.g., some of the empty values in the “AIR PERM VERT(MD)” column in FIG. 14), especially in larger tables. It will be appreciated that FIGS. 13 through 15 highlight the advantages that the hybrid combination of utilizing OCR-based pattern recognition or matching techniques and an LLM 34 descibed herein provide.

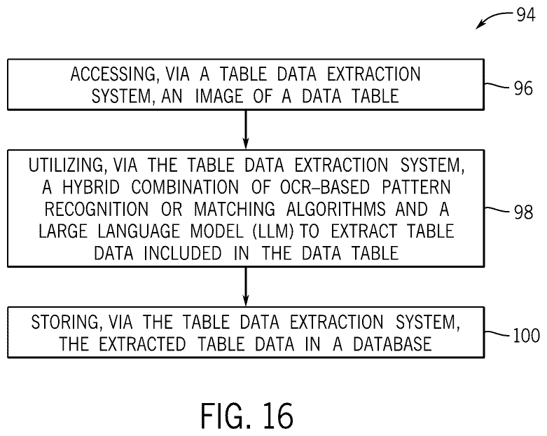

In addition, while the embodiments described herein address the challenges of relatively complex layouts and relatively large tables, such techniques may be extended to the processing of tables having further complex layouts, such as nested tables. One non-limiting example of how to do this may include the steps of:
(1) For complex layout tables/nested tables, the first step could be to use table detector algorithms (e.g., LLM/ML/deep learning based) which may determine the bounding boxes 58 for each of the nested tables.
(2) For each detected nested table, the embodiments described above may then be utilized to extract the tabular content.
(3) Then, the output of the table detectors may be used to identify the nested table locations with respect to each other and, accordingly, relate nested tables to each other.
FIG. 16 is a flow diagram of a method 94 for utilizing the table data extraction system 12 to extract table data from table images 32, as described in greater detail herein. For example, in certain embodiments, the method 94 may include accessing, via a table data extraction system 12, an image 32 of a data table (block 96). In addition, in certain embodiments, the method 94 may include utilizing, via the table data extraction system 12, a hybrid combination of optical character recognition (OCR)-based pattern recognition or matching algorithms and an LLM 34 to extract table data 92 included in the data table (block 98). In addition, in certain embodiments, the method 94 may include storing, via the table data extraction system 12, the extracted table data 92 in a database 14 (block 100).

In addition, in certain embodiments, the method 94 may include pre-processing, via the table data extraction system 12, the image 32 of the data table to provide skew correction, for example, by correctly aligning columns and rows included in the data table orthogonally within the image 32 of the data table.

In addition, in certain embodiments, the method 94 may include utilizing, via the table data extraction system 12, the LLM 34 to determine column names and respective values of a first row included in the data table.

In addition, in certain embodiments, the method 94 may include utilizing, via the table data extraction system 12, the OCR-based pattern recognition or matching algorithms to extract text and associated bounding boxes 58 for all detected words included in the data table.

In addition, in certain embodiments, the method 94 may include merging, via the table data extraction system 12, the column names 60 determined using the LLM 34 and the text and associated bounding boxes 58 extracted using the OCR-based pattern recognition or matching algorithms into a cropped version of the image 32 of the data table.

In addition, in certain embodiments, the method 94 may include utilizing, via the table data extraction system 12, the OCR-based pattern recognition or matching algorithms to detect column bounding boxes 68 and row bounding boxes 70 for the cropped version of the image 32 of the data table.

In addition, in certain embodiments, the method 94 may include mapping, via the table data extraction system 12, data included in the detected column bounding boxes 68 and row bounding boxes 70 to output a list 74 of data.

In addition, in certain embodiments, the method 94 may include cropping, via the table data extraction system 12, the column names 60 determined using the LLM 34 and a subset of rows (Sᵣ) 80 included in the list 74 of data having values for all columns included in the list 74 of data.

In addition, in certain embodiments, the method 94 may include generating, via the table data extraction system 12, a first output 84 defining the column names 60 determined using the LLM 34 and the subset of rows (Sᵣ) 80 included in the list 74 of data having values for all columns included in the list 74 of data.

In addition, in certain embodiments, the method 94 may include utilizing, via the table data extraction system 12, the first output 84 to generate a second output 88 that defines a mapping of structural columns to column names.

In addition, in certain embodiments, the method 94 may include applying, via the table data extraction system 12, the second output 88 to the list 74 of the data to output the extracted table data 92.

In addition, in certain embodiments, the method 94 may include automatically modifying, via the table data extraction system 12, the OCR-based pattern recognition or matching algorithms during processing of a plurality of images 32 of data tables.

In addition, in certain embodiments, the method 94 may include automatically retraining, via the table data extraction system 12, the LLM 34 during processing of a plurality of images 32 of data tables.

The embodiments described herein address the need for accurate and efficient extraction of structured data from tables in images, particularly for relatively large or complex layouts where traditional deep learning methods and LLM-based methods fail. The embodiments described herein enable reliable handling of non-standard arrangements, blank cells, and inconsistent structures while minimizing processing latency and cost and improving LLM limitations relating to relatively poor accuracy, as described in greater detail herein. The approach enhances accuracy and scalability for extracting tabular data from challenging image inputs.

The embodiments described herein solve these needs by using a structured process to accurately detect rows, columns, and headers, even in relatively complex tables. The embodiments described herein simplify the task by processing smaller parts of the table step-by-step and prompting an LLM when needed, thereby reducing errors, delays, and costs. This approach makes table data extraction faster, more reliable, and more efficient. In addition, the embodiments described herein reduce latency and cost and improve conventional LLM limitations of poor accuracy, and so forth.

Some potential applications of the embodiments described herein may include, among others, digitizing legacy documents containing tabular data for research, legal, or financial purposes; and automating data extraction for analytics from scanned receipts, invoices, and reports. In addition, future uses and alternatives may include, among others, integration into enterprise document management systems to automate data extraction; and extending the methodology to extract tables from videos or dynamic visual content.

Aspects of the embodiments described herein that are improvements over existing technology may include, among others, robust handling of complex table layouts, including large tables with many rows or columns and non-standard formats; and cost and time efficiency through intelligent pre-processing and selective LLM usage. Advantages over existing technologies that improve the functionality of the table data extraction system 12 described herein, may include, among others:
Higher accuracy: The embodiments described herein are superior to traditional deep learning or naive multimodal LLM-based methods.
Scalability: The embodiments described herein efficiently process relatively large and complex tables.
Cost-effectiveness: The embodiments described herein minimize token usage and computational overhead.

As such, the embodiments described herein may be used to help digitize old records; automate table extraction for tasks like finance, law, and research; and improve document processing systems. The embodiments described herein make table extraction more accurate and efficient, making it useful for large projects and data analysis.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]. . . ” or “step for [perform]ing [a function]. . . ”, it is intended that such elements are to be interpreted under 35 U.S.C. §112(f). However, for any claims containing elements designated in any other manner, it is intended that such elements are not to be interpreted under 35 U.S.C. § 112(f).

1. A method, comprising:
accessing, via a table data extraction system, an image of a data table;
utilizing, via the table data extraction system, a hybrid combination of optical character recognition (OCR)-based pattern recognition or matching algorithms and a large language model (LLM) to extract table data included in the data table; and
storing, via the table data extraction system, the extracted table data in a database.

2. The method of claim 1, comprising pre-processing, via the table data extraction system, the image of the data table to provide skew correction within the image of the data table.

3. The method of claim 1, comprising utilizing, via the table data extraction system, the LLM to determine column names and respective values of a first row included in the data table.

4. The method of claim 3, comprising utilizing, via the table data extraction system, the OCR-based pattern recognition or matching algorithms to extract text and associated bounding boxes for all detected words included in the data table.

5. The method of claim 4, comprising merging, via the table data extraction system, the column names determined using the LLM and the text and associated bounding boxes extracted using the OCR-based pattern recognition or matching algorithms into a cropped version of the image of the data table.

6. The method of claim 5, comprising utilizing, via the table data extraction system, the OCR-based pattern recognition or matching algorithms to detect column bounding boxes and row bounding boxes for the cropped version of the image of the data table.

7. The method of claim 6, comprising mapping, via the table data extraction system, data included in the detected column bounding boxes and row bounding boxes to output a list of data.

8. The method of claim 7, comprising cropping, via the table data extraction system, the column names determined using the LLM and a subset of rows included in the list of data having values for all columns included in the list of data.

9. The method of claim 8, comprising generating, via the table data extraction system, a first output defining the column names determined using the LLM and the subset of rows included in the list of data having values for all columns included in the list of data.

10. The method of claim 9, comprising utilizing, via the table data extraction system, the first output to generate a second output that defines a mapping of structural columns to column names.

11. The method of claim 10, comprising applying, via the table data extraction system, the second output to the list of data to output the extracted table data.

12. The method of claim 1, comprising automatically modifying, via the table data extraction system, the OCR-based pattern recognition or matching algorithms during processing of a plurality of images of data tables.

13. The method of claim 1, comprising utilizing, via the table data extraction system, the hybrid combination of the OCR-based pattern recognition or matching algorithms and the LLM to extract table data included in a plurality of data tables that are nested within the image by identifying locations of each data table of the plurality of data tables with respect to each other within the image prior to extracting the table data.

14. A table data extraction system, comprising:
one or more processors configured to execute processor-executable instructions stored in memory of the table data extraction system, wherein the processor-executable instructions, when executed by the one or more processors cause the table data extraction system to:
access an image of a data table;
utilize a hybrid combination of optical character recognition (OCR)-based pattern recognition or matching algorithms and a large language model (LLM) to extract table data included in the data table; and
store the extracted table data in a database.

15. The table data extraction system of claim 14, wherein the processor-executable instructions, when executed by the one or more processors cause the table data extraction system to pre-process the image of the data table to provide skew correction within the image of the data table.

16. The table data extraction system of claim 14, wherein the processor-executable instructions, when executed by the one or more processors cause the table data extraction system to utilize the LLM to determine column names and respective values of a first row included in the data table.

17. The table data extraction system of claim 16, wherein the processor-executable instructions, when executed by the one or more processors cause the table data extraction system to utilize the OCR-based pattern recognition or matching algorithms to extract text and associated bounding boxes for all detected words included in the data table.

18. The table data extraction system of claim 17, wherein the processor-executable instructions, when executed by the one or more processors cause the table data extraction system to merge the column names determined using the LLM and the text and associated bounding boxes extracted using the OCR-based pattern recognition or matching algorithms into a cropped version of the image of the data table.

19. The table data extraction system of claim 18, wherein the processor-executable instructions, when executed by the one or more processors cause the table data extraction system to utilize the OCR-based pattern recognition or matching algorithms to detect column bounding boxes and row bounding boxes for the cropped version of the image of the data table.

20. The table data extraction system of claim 19, wherein the processor-executable instructions, when executed by the one or more processors cause the table data extraction system to map data included in the detected column bounding boxes and row bounding boxes to output a list of data.

21. The table data extraction system of claim 20, wherein the processor-executable instructions, when executed by the one or more processors cause the table data extraction system to crop the column names determined using the LLM and a subset of rows included in the list of data having values for all columns included in the list of data.

22. The table data extraction system of claim 21, wherein the processor-executable instructions, when executed by the one or more processors cause the table data extraction system to generate a first output defining the column names determined using the LLM and the subset of rows included in the list of data having values for all columns included in the list of data.

23. The table data extraction system of claim 22, wherein the processor-executable instructions, when executed by the one or more processors cause the table data extraction system to utilize the first output to generate a second output that defines a mapping of structural columns to column names.

24. The table data extraction system of claim 23, wherein the processor-executable instructions, when executed by the one or more processors cause the table data extraction system to apply the second output to the list of data to output the extracted table data.

25. The table data extraction system of claim 14, wherein the processor-executable instructions, when executed by the one or more processors cause the table data extraction system to automatically modify the OCR-based pattern recognition or matching algorithms during processing of a plurality of images of data tables.

26. A method, comprising:
accessing, via a table data extraction system, a list of data extracted from a data table included in an image;
utilizing, via the table data extraction system, a text-based large language model (LLM) to determine column names and respective values of a first row included in the data table.
generating, via the table data extraction system, a first output defining the column names determined using the text-based LLM and a subset of rows included in the list of data having values for all columns included in the list of data;
utilizing, via the table data extraction system, the first output to generate a second output that defines a mapping of structural columns to column names;
applying, via the table data extraction system, the second output to the list of data to output extracted table data; and
storing, via the table data extraction system, the extracted table data in a database.
